(19) United States
(12) Patent Application Publication
(10) Pub. No.: US 2014/0124067 A1
(43) Pub. Date: May 8, 2014

(54) VALVE AND HYDRAULIC CONTROL

(71) Applicants: Hubert Feser, Gemuenden (DE); Georg Hofmann, Karsbach (DE)

(72) Inventors: Hubert Feser, Gemuenden (DE); Georg Hofmann, Karsbach (DE)

(73) Assignee: Robert Bosch GmbH, Stuttgart (DE)

(21) Appl. No.: 14/008,718

(22) PCT Filed: Apr. 2, 2012
(86) PCT No.: PCT/EP2012/001447

§ 371 Date: Jan. 10, 2014

(30) Foreign Application Priority Data
Apr. 1, 2011 (DE) 102011015904.5

(51) Int. Cl. F15B 13/04; F16K 37/00

(52) U.S. Cl. CPC F15B 13/04; F16K 37/00
USPC 137/551

(57) ABSTRACT

A valve includes a valve housing that defines a cylinder bore and a control slide that is disposed so as to be slidably mounted in the cylinder bore. The control slide has an axial position in the cylinder bore that is detectable in a contactless manner by a position sensor which generates a corresponding electrical position signal. The control slide has a change in diameter in a detection zone on an outer surface thereof. On the basis of the radial distance of the respective area of the control slide opposite the position sensor from the position sensor, the position signal is configured to be generated by the position sensor. In one embodiment, the position sensor is formed as a proximity sensor and is disposed so as to be directed radially with respect to the cylinder bore in a receiving recess of the valve housing.

The invention relates to a valve having a control slide which is arranged axially displaceably in a cylinder bore of a valve housing and the axial position of which in the cylinder bore can be detected contactlessly by way of a position sensor which generates a corresponding electric position signal. In addition, the invention concerns a hydraulic control circuit which has a valve of this type.

In valves of this type, the position of the control slide is to be detected, in order for it to be possible to derive the degree of opening of the valve therefrom, whereby regulating or control functions of the valve can be carried out.

It is an object of the invention to provide a valve of the type mentioned at the outset and a hydraulic control circuit having a valve of the type mentioned at the outset, it being possible in a simple way to reliably detect a switching position or a position of the control slide.

According to the invention, this object is achieved by virtue of the fact that the control slide has a change in its diameter in a detecting region on its circumferential face, and the position signal can be generated, depending on the radial spacing of that region of the control slide which lies in each case opposite the position sensor from the position sensor, by the position sensor which is configured as a proximity sensor and is arranged in a receiving recess of the valve housing such that it is directed radially with respect to the cylinder bore.

With respect to the axial extent of the control slide, the position of the receiving recess which is directed radially with respect thereto always remains constant, with the result that the position of the position sensor relative to the control slide also does not change, even in the case of the position sensor being replaced.

No essential adjusting work is therefore required during the installation of a new position sensor; in fact, adjusting work can even be dispensed with completely.

One embodiment of the control slide consists in that the control slide has one or more steps of different diameter axially one behind another in the detecting region.

This results in signal jumps which make an exact digital position determination possible when the steps which are arranged at predefined positions in the detecting region of the control slide move past the position sensor.

Another embodiment of the control slide consists in that the control slide has a continuously increasing or decreasing diameter over an axial detecting length in the detecting region.

This leads to an analog change in the signal of the position sensor when the detecting region of the control slide moves past the position sensor, the respective magnitude of the signal corresponding exactly to a defined position of the control slide. A valve of this nature can advantageously be incorporated with the position sensor into an electrohydraulic regulating circuit.

One advantageous embodiment which leads to a position signal which can be evaluated satisfactorily consists in that the control slide is composed of an electrically conductive material, and the position sensor is an inductive proximity sensor.

It goes without saying that other position sensors, such as Hall sensors, can also advantageously be used.

For simple assembly and dismantling, the receiving recess can be a bore which is provided completely or partially over its length with a thread and into which the position sensor which is provided with an external thread can be screwed.

If an axial stop is formed on the position sensor and the position sensor can be screwed into the bore which is provided with the thread until the stop comes into contact with a corresponding stop of the valve housing, an increase in the accuracy of the position detection is brought about by way of the additional fixing of the spacing of the position sensor from the detecting region of the control slide.

A plurality of position sensors can be arranged offset axially and/or radially with respect to one another in the valve housing for redundant detection and/or for the detection of a plurality of detecting regions of the control slide.

The control slide can be driven such that it can be moved between a closed position and an open position, it being possible for a connection from an inlet into the cylinder bore to an outlet in the cylinder bore to be shut off by the control slide in the closed position. Here, the closed position of the control slide can preferably be detected by the position sensor.

Here, the cylinder bore can have an axial valve seat, against which the control slide can bear with a corresponding seat face in its closed position, it being possible for the valve seat-side end face of the control piston to be loaded in the opening direction by the pressure at the inlet counter to a control force.

Here, if that end face of the control slide which is remote from the valve seat can be loaded in the closing direction by a control pressure and/or a control spring, regulation of the control pressure which loads the control slide in the closing direction can take place depending on the position signal, and the pressure at the inlet of the valve can be regulated.

Furthermore, if the valve seat is arranged at an axial spacing from the radial outlet or outlets and, at its valve seat-side end region, the control slide is configured as a damping peg with a smaller diameter than the cylinder bore, in such a way that an annular space which encloses the damping peg is formed between the valve seat and the outlet in the closed position of the control slide, the closing movement is damped in its final part. By way of the smooth movement of the control slide which results herefrom, the position of said control slide can also be detected with increased exactness.

Advantageous developments of the present invention are the subject matter of the subclaims.

Exemplary embodiments of the invention are shown in the drawing and will be described in greater detail in the following text. In the drawings:

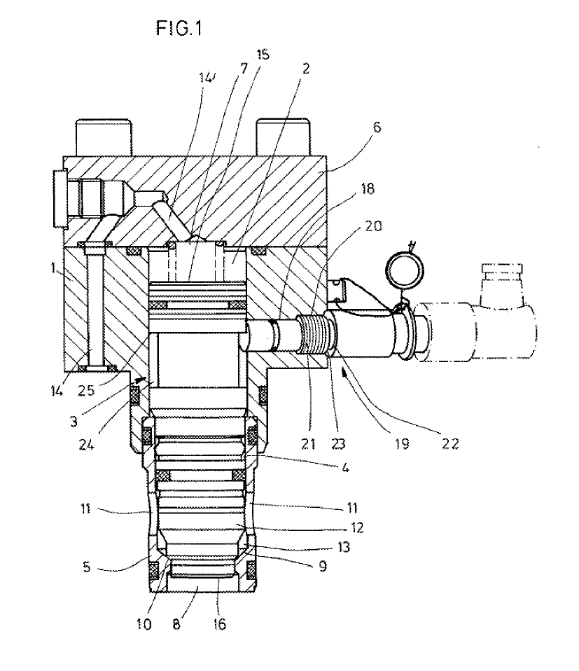

FIG. 1 shows a cross section of a first exemplary embodiment of a valve,

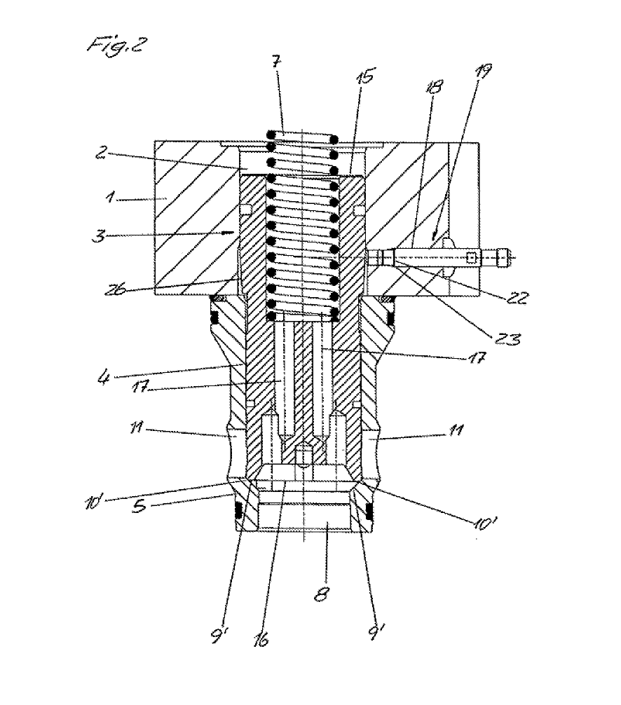

FIG. 2 shows a cross section of a second exemplary embodiment of a valve, and

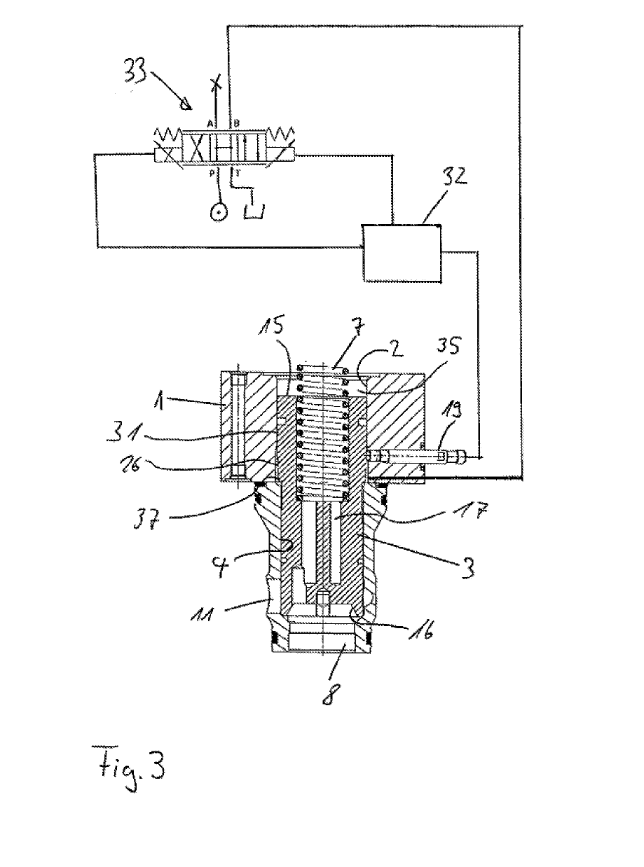

FIG. 3 shows a hydraulic control circuit with a valve of this type.

The valves which are shown have a valve housing 1 with a first cylinder bore 2.

A part of a control slide 3 is arranged axially displaceably in the first cylinder bore 2.

The other part of the control slide 3 protrudes into a second cylinder bore 4 which is coaxial with respect to the first cylinder bore 2, in a liner 5 which is connected fixedly to the valve housing 1.

That end of the first cylinder bore 2 which faces away from the liner 5 is closed by a cover 6 which is connected fixedly to the valve housing 1 (not shown in FIG. 1), on which cover 6 a prestressed control spring 7 is supported with its one end. The control spring loads the control slide 3 with its other end.

The second cylinder bore 4 is formed continuously in the liner 5, that opening of the second cylinder bore 4 which is opposite the valve housing 1 forming an inlet 8 of the valve.

An axial valve seat 9, 9′ is formed on the inlet side in the second cylinder bore 4, against which axial valve seat 9, 9′ the control slide 3 can bear with a seat face 10, 10′ so as to close the inlet 8.

In FIG. 1, both the valve seat 9 and the seat face 10 are configured in the manner of an annular cone.

In FIG. 2, the valve seat 9′ is a radially extending annular face on the left-hand side, whereas it is shown as an annular cone on the right-hand side.

The seat face 10′ of the control slide 3 is configured as an annular face.

A continuous outlet 11 is formed in the liner 5 transversely with respect to the longitudinal extent of said liner 5, a connection from the inlet 8 to the outlet 11 being shut off if the seat face 10, 10′ rests on the valve seat 9, 9′.

In FIG. 1, the valve seat 9 is at an axial spacing from the outlet 11.

Furthermore, the control slide 3 is configured at its valve seat-side end region as a damping peg 12 of smaller diameter than the second cylinder bore 4, with the result that an annular space 13 which encloses the damping peg 12 is formed between the valve seat 9 and the outlet 11 in the closed position of the control slide 3.

As a result, damping of the closing movement occurs in the end phase of said closing movement.

In the exemplary embodiment of FIG. 1, the closing movement is brought about by the force of the control spring 7 and the control pressure which is fed via channels 14, 14′ in the valve housing 1 and cover 6 to the first end face 15 which lies opposite the inlet 8, which control pressure acts on said end face 15.

Said closing movement is counteracted by the pressure at the inlet 8, which pressure loads the valve-side second end face 16 of the control slide 3.

In the exemplary embodiment of FIG. 2, the pressure at the inlet 8 is also guided via continuous axial channels 17 in the control slide 3 to the first end face 15 of the control slide 3, which end face 15 faces away from the inlet 8.

Since the first end face 15 is larger than the second end face 16, the pressure at the inlet 8 which acts on the differential area between the first and second end face 15 and 16 acts on the control slide 3 in the closing direction in addition to the force of the control spring 7.

A receiving recess 18 which leads radially from the outside to the first cylinder bore 2 is formed in the valve housing 1.

An inductive proximity sensor 19 is inserted into the receiving recess 18, which proximity sensor 19 outputs a position signal depending on its spacing from a detecting region of the control slide 3, which detecting region lies opposite said proximity sensor 19.

In FIG. 1, the receiving recess 18 is a bore which is provided partially with a thread 20 and into which the proximity switch 19 which is provided with an external thread 21 is screwed.

An annular axial stop 22 is formed on the proximity sensor 19 by way of a radial widened portion, which stop 22 is in contact with a corresponding stop 23 of the valve housing 1 when the proximity sensor 19 has been screwed in, and which stop 22 determines the exact spacing of the proximity sensor from the control slide 3.

In FIG. 2, the receiving recess 18 is a stepped bore, the transition of which from the radially outer large step to the radially inner small step forms a corresponding stop 23, with which a stop 22 of the proximity sensor 19 which is of correspondingly stepped configuration is in contact when the proximity sensor 19 is inserted into the stepped bore, and which corresponding stop 23 determines the exact spacing of the proximity sensor 19 from the control slide 3.

In FIG. 1, the control slide 3 is configured with an annular groove 24 on its radially circumferential outer face in the region of the valve housing 1, with the result that the groove side wall which is remote from the inlet 8 forms a radial step 25.

At said step 25, the radial spacing of the sensor region of the proximity sensor 19 from the control slide 3 which is composed of an electrically conducting material changes suddenly.

The position signal which is generated by the proximity sensor 19 also changes correspondingly suddenly when, during a displacement movement of the control slide 3, its step 25 passes into the region of the proximity sensor 19. This change in the position signal indicates the position of the control slide 3 at this moment.

In FIG. 2, instead of an annular groove, the control slide 3 is configured on its radially circumferential outer face with a cone 26 which extends over an axial detecting length. Here, the diameter of the cone 26 decreases continuously from the end which is further away from the inlet 8 to that end of the cone 26 which is closer to the inlet 8.

In accordance with the respective radial spacing between the proximity sensor 19 and the instantaneous region of the cone 26 of the control slide 3 which is composed of an electrically conducting material, a corresponding position signal which indicates the instantaneous position of the control slide 3 is generated by the proximity sensor 19.

FIG. 3 shows a hydraulic control circuit, in which the valve according to the second exemplary embodiment is used.

The valve is incorporated with its two connectors 8 and 11 into a hydraulic circuit. By way of axial adjustment of the control slide 3, an opening cross section between the connectors 8 and 11 is opened, closed or has its cross-sectional area changed.

A control collar 31 which is guided in the bore 2 separates the spring space 35 from an annular chamber 37 which is delimited in this case by the cone 26 of the control slide 3, and would be delimited by the step 25 in the case of a valve in accordance with exemplary embodiment 1.

The control slide 3 can be moved in the closing direction and the opening direction by loading of the end face 15 which delimits the spring space 35 and by loading of the annular face which results on the cone 26 and delimits the annular chamber 37, respectively.

In this case, the end face 15 is connected permanently to the connector 8 with the aid of the axial passage channel 17, with the result that the same fluidic pressure prevails in the spring space as in the connector 8. The annular chamber 37 is actuated with hydraulic fluid via the proportionally adjustable pilot valve 33. The pilot valve 33 itself is actuated electrically by control electronics 32. The signal of the proximity sensor 19 is fed to the control electronics 32. Said control electronics 32 obtain or additionally generate a setpoint value which stipulates the setpoint position of the control slide 3.

The pressure which prevails on the end faces 15 and 16 brings about an effective force on the control slide 3 which is directed in the closing direction, as a result of the excess area on the face 15 and together with the control spring 7. The control slide 3 can be moved in the direction of the open position counter to this closing force by way of fluid being fed into the annular chamber 37 by means of the pilot valve 33. A movement of the control slide 3 in the closing direction is brought about by way of fluid being discharged from the annular chamber 37 by means of the pilot valve 33.

The position of the control slide 3 is detected as a continuous, constant and analog signal by way of the proximity sensor 19 with the aid of the cone 26. Said position signal is fed to the control electronics 32 as actual position signal of the control slide 3. The actual position signal is compared with the setpoint position signal in the control electronics 32. If there is a deviation between the actual position signal and the setpoint position signal, the pilot valve 33 is actuated correspondingly, in order to bring about a displacement of the control slide 3 in the direction of a reduction of the deviation.

The pilot valve 33 is shown as a 4/3-way proportional valve. A 3/3-way proportional valve can also be used, since only one outlet of the pilot valve 33 is required in the circuit which is shown.

A hydraulic control circuit can also be constructed with a valve in accordance with exemplary embodiment 1. In this case, the digital output signal of the proximity switch 19 can be used to switch, for example, further hydraulic units on or off, depending on whether the output signal of the proximity switch 19 indicates opening of the valve or not. For example, the closed position can also be detected, in order for it to be possible to detect a secure state of a hydraulic system, in which a consumer which is connected to the valve is shut off.

### LIST OF DESIGNATIONS

1 Valve housing
2 First cylinder bore
3 Control slide
4 Second cylinder bore
5 Liner
6 Cover
7 Control spring
8 Inlet
9 Valve seat
9′ Valve seat
10 Seat face
10′ Seat face
11 Outlet
12 Damping peg
13 Annular space
14 Channel
14′ Channel
15 First end face
16 Second end face
17 Axial channels
18 Receiving recess
19 Proximity sensor
20 Thread
21 External thread
22 Stop
23 Corresponding stop
24 Annular groove
25 Step
26 Cone
31 Control collar
32 Control electronics
33 Pilot valve
35 Spring space
37 Annular chamber

1. A valve, comprising:
a valve housing defining a cylinder bore;
a control slide arranged axially displaceably in the cylinder bore; and
a position sensor configured to contactlessly detect an axial position of the control slide in the cylinder bore and to generate a corresponding electric position signal,
wherein the control slide has a change in its diameter in a detecting region on its circumferential face,
wherein, depending on the radial spacing of that region of the control slide which lies in each case opposite the position sensor from the position sensor, the position signal is configured to be generated by the position sensor, and
wherein the position sensor is configured as a proximity sensor and is arranged in a receiving recess of the valve housing such that it is directed radially with respect to the cylinder bore.

2. The valve as claimed in claim 1, wherein the control slide has one or more steps of different diameter axially spaced from one another in the detecting region.

3. The valve as claimed in claim 1, wherein the control slide has a continuously increasing or decreasing diameter over an axial detecting length in the detecting region.

4. The valve as claimed in claim 1, wherein the control slide is composed of an electrically conductive material, and wherein the position sensor is an inductive proximity sensor.

5. The valve as claimed in claim 1, wherein the receiving recess is a bore configured with a thread completely or partially over its length, and wherein the position sensor has an external thread and is configured to be screwed into the bore.

6. The valve as claimed in claim 5, wherein an axial stop is formed on the position sensor, and wherein the position sensor is configured to be screwed into the bore until the stop comes into contact with a corresponding stop of the valve housing.

7. The valve as claimed in claim 1, wherein a plurality of position sensors are arranged offset axially and/or radially with respect to one another in the valve housing.

8. The valve as claimed in claim 1, wherein the control slide is configured to be moveably driven between a closed position and an open position, and wherein a connection from an inlet into the cylinder bore to an outlet in the cylinder bore is configured to be shut off by the control slide in the closed position.

9. The valve as claimed in claim 8, wherein the cylinder bore has an axial valve seat against which the control slide bears with a corresponding seat face in its closed position, and wherein a valve seat-side end face of the control piston is configured to be loaded in the opening direction by the pressure at the inlet counter to a control force.

10. The valve as claimed in claim 9, wherein the valve seat is arranged at an axial spacing from the radial outlet or outlets and wherein, at its valve seat-side end region, the control slide is configured as a damping peg with a smaller diameter than the cylinder bore such that an annular space which encloses the damping peg is formed between the valve seat and the outlet in the closed position of the control slide.

11. A hydraulic control circuit, comprising:
a valve including:
a valve housing defining a cylinder bore;
a control slide arranged axially displaceably in the cylinder bore; and
a position sensor configured to contactlessly detect an axial position of the control slide in the cylinder bore and to generate a corresponding electric position signal,
wherein the control slide has a change in its diameter in a detecting region on its circumferential face,
wherein, depending on the radial spacing of that region of the control slide which lies in each case opposite the position sensor from the position sensor, the position signal is configured to be generated by the position sensor, and
wherein the position sensor is configured as a proximity sensor and is arranged in a receiving recess of the valve housing such that it is directed radially with respect to the cylinder bore.

12. The hydraulic control circuit as claimed in claim 11, further comprising:
electronics which are fed a signal from the proximity sensor; and
a hydraulic unit which is actuated by the electronics depending on the signal of the proximity sensor.

13. The hydraulic control circuit as claimed in claim 12, wherein the proximity sensor and the valve are configured in such a way that the signal of the proximity sensor continuously and proportionally represents a position of the control slide, and wherein the electronics are formed and configured as control electronics so as to regulate a position of the control slide according to a setpoint position stipulation.

14. The hydraulic control circuit as claimed in claim 13, wherein the hydraulic unit is configured as a pilot valve arranged for the hydraulic adjustment of the control slide.

15. The hydraulic control circuit as claimed in claim 11, wherein an end face of the control slide which is remote from the valve seat is configured to be loaded in the closing direction by a control pressure and/or a control spring, wherein a regulation of the control pressure which loads the control slide in the closing direction is performed by a controller depending on a position signal of the proximity sensor, and wherein the pressure at the inlet of the valve is configured to be regulated.

16. The hydraulic control circuit as claimed in claim 13, wherein the control slide has a continuously increasing or decreasing diameter over an axial detecting length in the detecting region.

17. The hydraulic control circuit as claimed in claim 14, wherein the pilot valve is configured as a proportionally adjustable directional valve.
